(19) United States
(12) Patent Application Publication
(10) Pub. No.: US 2001/0030710 A1
(43) Pub. Date: Oct. 18, 2001

(54) System and method for associating subtitle data with cinematic material

(76) Inventor: William B. Werner, Plano, TX (US)

Correspondence Address: TEXAS INSTRUMENTS INCORPORATED, P O BOX 655474, M/S 3999, DALLAS, TX, 75265

(21) Appl. No.: 09/728,181

(22) Filed: Dec. 1, 2000

Related U.S. Application Data
(60) Provisional application No. 60/171,720, filed on Dec. 22, 1999.

(51) Int. Cl. H04N 7/00; H04N 7/084

(52) U.S. Cl. 348/467; 348/473

(57) ABSTRACT

A subtitled electronic cinematic feature includes a series of image data packets (21-29) residing in a signal structure that may be electronically transferred over a communication link (33). The subtitled electronic cinematic feature also includes subtitle data (50) inserted into the series and associated with at least one of the image data packets (21-29). More specifically, the subtitle data (50) include text data (206) and style data to be used to display the text data (206) with data from the at least one of the associated image data packets (21-29). In a further embodiment, the subtitle data (50) include at least one caption packet (100-110).

### TECHNICAL FIELD OF THE INVENTION

This invention relates generally to the field of cinema presentation and more particularly to a system and method for associating subtitle data into cinematic material.

### BACKGROUND OF THE INVENTION

In the production of cinematic materials, original film negatives are typically processed to produce a number of intermediate film elements. For example, original film negatives are usually edited and an inter-positive print is produced therefrom. From this inter-positive, subtitle data may be added to films intended for foreign audiences, and an inter-negative may be produced therefrom. From this inter-negative, producers make thousands of distribution copies, or release prints, of the film, and send by courier the film to theaters around the world. These conventional duplication and distribution processes are typically expensive.

For example, each film must be duplicated for as many languages for which subtitles may be desirable to provide a unique inter-negative. This duplication requires significant expense and storage resources. Furthermore, a distributor must typically copy as well as distribute a unique film print for each language desired by a service provider, such as a theater operator. In addition, the distributor must utilize additional resources to store and maintain a plurality of inter-negative film elements. Therefore, it is desirable to avoid duplication based on insertion of varying forms of subtitles into films.

### SUMMARY OF THE INVENTION

From the foregoing, it may be appreciated that a need has arisen for providing films to different regions or countries without individually editing different copies of the film with subtitles for each country in the distribution chain. In accordance with the present invention, a system and method for associating subtitle data with cinematic material are provided that substantially eliminate or reduce disadvantages and problems of conventional systems.

According to an embodiment of the invention, there is provided a subtitled electronic cinematic feature including a series of image data packets residing in a signal structure that may be electronically transferred over a communication link. The subtitled electronic cinematic feature also includes subtitle data inserted into the series and associated with at least one of the image data packets. More specifically, the subtitle data include text data and style data to be used to display the text data with data from the at least one of the associated image data packets. In a further embodiment, the communication link is a wireless communication link. In yet another embodiment, the signal structure is transferred from a distributor using the communication link.

The invention provides several important technical advantages over conventional systems. Various embodiments of the present invention may include none, some, or all of these advantages. One technical advantage of the present invention is that it may reduce the number of intermediate film elements required. Another technical advantage of the present invention is that it may reduce the computer resources required by a distributor to store and to maintain the multiple film prints. Yet another technical advantage of the present invention is that it may allow simultaneous distribution of cinematic material to a service provider with many subtitled languages. Another technical advantage of the present invention is that it may provide a distributor flexibility in creating numerous styles and versions of a cinematic material within the same language or various languages.

Yet another technical advantage of the present invention is that it may reduce the computer resources required by a service provider to store and to maintain the multiple versions of a cinematic material in various languages. Yet another technical advantage of the present invention is that it allows a service provider to present one or more versions of a cinematic material in various languages as desired. For example, where a service provider presents the cinematic material in a multi-lingual region, the service provider may choose to present more than one language. Another technical advantage is that the present invention may provide the service provider more flexibility in presenting cinematic material. Yet another technical advantage of the present invention is that it allows the service provider to present cinematic material virtually simultaneously as it is received from a distributor. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following description taken in connection with the accompanying drawings, wherein like reference numerals represent like parts, in which:

FIG. 1 illustrates one embodiment of a data transport stream that may be electronically distributed and used to present cinematic material;

FIG. 2 illustrates an example of a subtitle data packet that may be used in the data transport stream; and

FIG. 3 illustrates an example of a subtitle caption packet that may be used in the subtitle data packet.

### DETAILED DESCRIPTION OF THE DRAWINGS

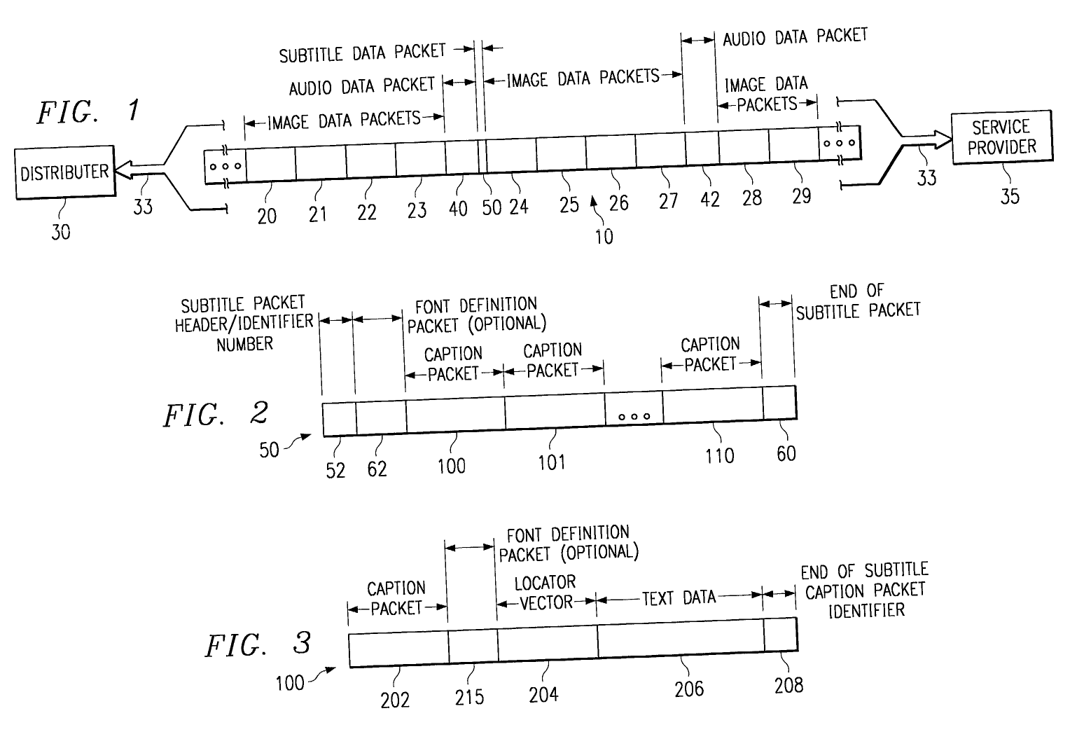

FIG. 1 illustrates one example of a data transport stream 10 that may be electronically distributed and used to present cinematic material, such as films, videos, or motion pictures (cinematic features). Data transport stream 10 may be any suitable signal structure that may be electronically transferred over communication link 33. For example, data transport stream 10 may be a signal structure that may be transferred over a computer network. Alternatively, data transport stream 10 may be a signal structure that may be transferred over fiber optic or satellite communication links 33. For example, communication link 33 is operable to transfer a wide variety of data in addition to data transport stream 10, and may be, but is not limited to, a wide area network (WAN), a public or private network, a global data network such as the Internet, an antenna, a telephone line, or any fiber optic, wireline or wireless link such as a satellite link. Communication link 33 may also be a Digital Subscriber Line (DSL), or any variety thereof.

Data transport stream 10 includes a series of image data packets 21-29, one or more audio data packets 40, and one or more subtitle data packets 50. In operation, data transport stream 10 may be used to transport, store, distribute and/or present the series of image data packets 21-29. For example, a distributor 30 may transport data transport stream 10 to a service provider 35 over communications link 33. It is contemplated that data transport stream 10 may be received, maintained, used, and/or presented by any one or a combination of service providers 35 such as theater owners or operators, or any other entity or organization seeking to present cinematic features using data transport stream 10. Service providers 35 may also include entities who transfer data stream 10 to entities that present cinematic features using data transport stream 10.

In one embodiment, the series of image data packets 21-29 may represent some or all of a series of image frames of a cinematic feature. Distributor 30 may perform a variety of functions during the filming, authoring, editing, duplication, distribution, etc. processes typically performed in preparing the cinematic feature for distribution and/or presentation. Distributor 30 may perform some or all of these functions. For example, distributor 30 may process and/or digitize image frames from original film elements or from an inter-positive print derived therefrom. Distributor 30 may typically partition image and audio data from the cinematic feature into image and audio data packets as shown in FIG. 1. Distributor 30 then may add one or more subtitle data packets similar to the ones illustrated in FIG. 1 in a suitable format and size to be presented with the image and audio data packets. Distributor 30 may then store the cinematic feature in some suitable storage medium, such as a hard disk, digital audio tape (DAT), optical disk such as CD-ROM or Digital Video Disc-ROM (DVD-ROM), etc. (not explicitly shown), to retain the feature for archival purposes and/or subsequent distribution. Distributor 30 may then use a variety of known methods to distribute data stream 10 to one or more service providers 35. Distributor 30 may include, but is not limited to, one or more entities such as a studio, film duplication laboratory, or a satellite distribution facility. For example, where entities such as a studio and a film duplication laboratory perform only some of the previously discussed functions, distributor 30 may include both entities.

Each of the image data packets 21-29 may be represented within data transport stream 10 by a variety of suitable methods. For example, each image data packet 21-29 may include all of the image data for a single image frame. The series of image data packets 21-29 then represents successive image frames within the cinematic feature that may be presented using an electronic display device. The series may include more or fewer image data packets 21-29 as desired. The image data within each image data packet 21-29 may be represented by pixel data or any other suitable equivalent. Each image data packet 21-29 may be the same or a different size. For example, each image data packet 21-29 may represent a 1024×1024 image frame, which typically includes about 1.5 to 4 megabytes of data, where each pixel may range in size from 12 to 30 bits. Alternatively or in addition, each image data packet 21-29 may be stored as change data to a specified image frame rather than as successive image frames.

Data transport stream 10 may include any number of subtitle data packets 50 as desired, and each subtitle data packet 50 may be of the same or a different size. As will be discussed in conjunction with FIGS. 2 and 3, subtitle data packet 50 includes data and/or code to associate subtitle data packet 50 with at least one image data packet 21-29 in data transport stream 10. Typically, each subtitle data packet 50 includes textual data representing a varying number of one-byte characters. Thus, each subtitle data packet 50 is relatively small in size compared to an image data packet, and may be associated with one or more image data packets 21-29 as desired. For example, subtitle data packet 50 may be associated with image data packets 20-23, image data packets 24-29, or any other combination thereof. Subtitle data packet 50 may typically be associated with a large number of image frames such as between fifty and a few hundred.

Subtitle data packet 50 may also be inserted between a selected two of image data packets 21-29 or at the beginning of data transport stream 10. This flexibility may be designed as desired to accommodate the resources of distributor 30 and/or service provider 35. Where one or more subtitle data packets 50 is inserted at the beginning of data transport stream 10 or before one or more of its corresponding image data packets, presentation of the cinematic feature may also include using a memory suitably sized to accommodate all of the data within the one or more subtitle data packets 50. Then, each subtitle data packet 50 may be retrieved from the memory for presentation with its associated image data packets. Thus, where subtitle data packets 50 are inserted between two of image data packets 21-29, memory requirements for display devices and/or data libraries of service provider 35 may be reduced.

Data transport stream 10 may also include any number of audio data packets as desired. FIG. 1 illustrates two audio data packets 40 and 42 that each may also be relatively small in size compared to an image data packet, depending on the application. These audio data packets 40 and 42 may be associated with one or more image data packets 21-29. For example, audio data packet 40 may be associated with image data packets 24-27 and audio packet 42 may be associated with image data packets 28 and 29. Audio data packets 40 and 42 may be positioned as desired within data transport stream 10, either before, between, or after their associated image data packets. Alternatively, all of the audio data packets 40 that may be associated with the image data packets 21-29 in data stream 10 may be positioned at the beginning of data transport stream 10. Audio data packets 40 and 42 may also be of a standard or variable size.

Each of the data packets within data transport stream 10 may be compressed or uncompressed, or encrypted or unencrypted. On the other hand, it may be preferable to treat each of the types of data packets individually. For example, it may be preferable not to compress or encrypt subtitle data where lossy compression algorithms are used. In other embodiments, image data, audio data, and subtitle data may all be encrypted and/or compressed using different algorithms.

In operation, distributor 30 may suitably insert one or more subtitle data packets 50 into data stream 10 as desired. By inserting one or more subtitle data packets 50 into data stream 10, distributor 30 may produce a single data transport stream 10 with a variety of subtitle features for a single cinematic feature. This cinematic feature may include subtitles for a variety of languages in markets for which the cinematic feature may be distributed. Inclusion of a plurality of languages with a single cinematic feature may reduce the resources needed to otherwise maintain a plurality of cinematic features. For example, a distributor may create and/or maintain a single intermediate film element, rather than creating and/or maintaining multiple intermediate film elements. This inclusion also may reduce resources, such as bandwidth that would otherwise be required to distribute a plurality of cinematic features. Such inclusion may also reduce resources and improve flexibility for service providers 35 who desire to present the feature to as broad an audience base as possible. The subtitle data packets 50 may include control data that allow selection of a desired language from the plurality of languages that are included in the feature.

Similarly, this cinematic feature may include subtitle data packets 50 in a variety of styles to present the data within subtitle data packets 50. For example, where service provider 35 may cater to an elderly audience or children, subtitled text may be more easily viewed by utilizing large font sizes. This cinematic feature may also include subtitle data packets 50 having a variety of control data that affects how or where the data within subtitle data packets 50 may be inserted into one or more image frames as they are presented.

Distributor 30 may distribute or transfer data transport stream 10 using the signal structure to one or more service providers 35 using a signal structure suitable for fiber optic, wireline, and/or wireless communication over communication link 33. Communication link 33 may utilize any suitable network protocol and logical or functional configuration that provides for the passage of data transport stream 10 between distributor 30 and service provider 35. Communication link 33 may be, but is not limited to, a computer network, a satellite link, a fiber optic communication link, a gateway, an antenna, a telephone line, any variant of digital subscriber lines (DSL, VDSL, etc.), or combination thereof, or any other type of communication link that can meet data throughput and other requirements as needed. For example, distributor 30 may transfer data transport stream 10 using the signal structure to service provider 35 for simultaneous or near simultaneous presentation of the cinematic feature.

Service provider 35 may present data transport stream 10 using a variety of projection methods that are suitable to present subtitle data packets with their associated image data packets. In some applications, data transport stream 10 may be presented using an electronic display device, such as an electronic screen, or video monitor, such as a television or computer monitor. Electronic display devices also include, but are not limited to, electronic projectors that use a cathode ray tube to modulate light values or digital micro-mirror devices (DMDs).

Each of these display devices may be operable to read and/or process data from data transport stream 10 using a variety of methods. Alternatively or in addition, these display devices may work in concert with a processor residing elsewhere, such as in a computer or data library, to read and/or process data from data transport stream 10. For example, each display device may interpret each image data packet 21-29 as an image frame. Alternatively, each display device may read and/or process data stored in each image data packet 21-29 as change data. That is, the display device may use the change data to construct and present successive image frames. These display devices may also be operable to decompress and/or decrypt data from data transport stream 10. A display device may also read and/or process data within the audio and subtitle data packets so that they are synchronized with their associated image frames. Depending on the application, the display device may display data within subtitle data packet 50 in one or more image frames that may be derived from one or more image packets 21-29 that are associated with subtitle data packet 50.

FIG. 2 illustrates an example of a subtitle data packet that may be used in a data transport stream. Subtitle data packet 50 may be partitioned into any functional or other structure that may be used to display data such as text and/or graphics with one or more associated image data packets 21-29. As illustrated in FIG. 2, subtitle data packet 50 includes subtitle packet header or identifier 52, one or more caption packets 100-110, and an end of subtitle packet identifier 60. Subtitle data packet 50 may include as few or as many caption packets 100-110 as desired. Subtitle data packet 50 may also include an optional font definition packet 62.

Subtitle data packet header or identifier 52 includes, but is not limited to, information that identifies the type of subtitle packet, a language identifier, the number of caption packets to be expected, and any control data needed to extract data from subtitle data packet 50. These data may vary according to the application and/or display device and other resources available to distributor 30 and/or service provider 35.

For example, header 52 may indicate that it is a multi-language subtitle data packet, and that there are a number of caption packets for each language. For example, subtitle data packet 50 may be in the Portuguese language, and include three caption packets. As another example, header 52 may indicate that subtitle data packet 50 includes the German, Czech, and Spanish languages and that each language includes four caption packets. Alternatively, header 52 may indicate that subtitle data packet 50 is a single-language packet.

A variety of control data may be used to associate subtitle data packet 50 with one or more image frames, or one or more image data packets 21-29. For example, control data may include image frame counters or codes that associate one or more caption packets 100-110 with one or more image frames. The invention contemplates many suitable formats that may be used to implement this control data. For example, this control data may include, but is not limited to, a lookup table that may cross-reference portions of caption packets 100-110 to one or more image frames and/or executable code that may be assigned to one or more portions of caption packets 100-100. This control data may also include information that may be used to extract data from subtitle data packet 50 and/or to insert the data into one or more image frames using a variety of known methods. This control data may also be used to provide selection and/or presentation of one of a plurality of languages with the feature, where applicable.

Subtitle data packet 50 may include a plurality of caption packets 100-110 that may be arranged using many suitable methods. Each caption packet may include text and/or graphics that may correspond to, for example, spoken lines of a character or other sound effects in a cinematic feature. Thus, each of caption packets 100-110 may be one or more of the character's spoken lines, and/or may be arranged in sequential order of presentation. One example for a structure for a caption packet that may be used in a subtitle data packet 50 is described in further detail in conjunction with FIG. 3.

It may be desirable to include a number of language interpretations for subtitle data packet 50. By including a plurality of caption packets, distributor 30 may distribute data transport stream 10 to a plurality of service providers who may select and use caption packets as desired. For example, where multiple languages are used, subtitle data packet 50 may be organized using multiple caption packets for each language or multiple languages for each caption packet. As one example, caption packets 100 and 101 may include text that represents the same sound effects to be displayed using two different languages. As another example, caption packets 100 and 101 may include text that represents two successive sound effects to be displayed, where each caption packet includes data for the two different languages.

Font definition packet 62 may also optionally be included to provide commonality between a plurality of languages or a plurality of caption packets 100-110. Alternatively, a font definition packet 215 may optionally be included in one or more caption packets as desired, or as a portion of text data 206 as discussed in conjunction with FIG. 3. Font definition packet 62 may include information typically used to construct textual characters in a variety of languages. For example, font definitions may include information such as font styles and sizes. Font definition packet 62 may also include any executable code suitable to build a pixel bitmap that represents the desired textual character for that font. These bitmaps may then be used to display subtitle text data in one or more caption packets 100-110 with one or more image frames. The location and desirability of including font definition packet 62 depends on the application. For example, font definition packet 62 may be omitted where they are not needed by a processor to construct the textual character bitmaps and/or styles. Furthermore, font definition packet 62 may be desirably located to reduce processing resources or memory requirements for displaying the cinematic feature.

An end of subtitle packet 60 may also be used to identify the end of subtitle data packet 50 and/or to locate a subsequent subtitle data packet 50. End of subtitle packet 60 may also be used for error correction or data verification as desired. For example, end of subtitle packet 60 may be used to perform parity correction, and indicate an alarm or diagnostics signal when such errors arise.

FIG. 3 illustrates an example of a subtitle caption packet that may be used in a subtitle packet. Subtitle caption packet 100 may also be partitioned into any functional or other structure that may be used to display text data 206 with one or more associated image data packets 21-29. Subtitle caption packet 100 as illustrated in FIG. 3 includes caption packet header 202, locator vector 204, text data 206, and end of subtitle caption packet identifier 208. Depending on the application, subtitle caption packet 100 may also include an optional font definition packet 215. Font definition packet 215 may be used in place of, and include information similar to, font definition packet 62 to construct the textual characters necessary to display text data 206 with the associated image frames. Font definition packet 215 may also be included in text data 206 as a portion of style data.

Caption packet header 202 may be used to identify the beginning of subtitle caption packet 100 and to permit data within subtitle caption packet 100 to be extracted. For example, caption packet header 202 may include, but is not limited to, identifiers such as a packet identifier, packet length, language code, and error detection or correction information, as needed.

A packet identifier may be used to denote the sizes of variable caption packets 100-110. On the other hand, where caption packets 100-110 are each a standard size, it may be desirable to omit any packet length. This packet identifier may also be used to keep track of selected caption packets 100-110 as they are displayed with one or more associated image data packets 21-29.

Similarly, a language code identifier may be used to denote the number of languages represented in caption packets 100-110. This may be useful to identify the text data 206 corresponding to a selected language, where caption packets 100-110 are represented in a plurality of languages. Caption packet header 202 may omit a language code identifier in applications where, for example, distributor 30 may choose not to include a plurality of languages within a subtitle data packet 50. Other variations are also within the scope of the invention.

Caption packet header 202 may also include image association data that may be used in many ways to associate all, or portions of, text data 206 with one or more image frames. For example, text data 206 may represent one or more character's lines that is typically displayed over a plurality of successive image frames while the character speaks within the cinematic feature. On the other hand, text data 206 may include a plurality of portions representing lines for a plurality of characters. Each of these portions may be associated with the same or an overlapping plurality of image frames. The invention contemplates many suitable formats that may be used to implement image association data. For example, image association data may include, but is not limited to, control data, executable code, and/or lookup tables that associate text data 206, or portions thereof, to one or more image frames. Alternatively, image association data may include image frame counters that assign various portions of text data 206 to one or more image frames.

Locator vector 204 may be used to insert one or more portions of text data 206 into the associated image frames by using a variety of known methods. For example, in some applications, locator vector 204 may identify a lower left pixel at which to begin display of text data 206. Alternatively or in addition, locator vector 204 may include an image area or boundary that indicates where text data 206 is to be displayed within the associated image frames. Locator vector 204 may vary between caption packets, and also include other information that may be used to display text data 206, such as time and/or bitmap data to indicate whether text may be transparently displayed within an image frame, and so on.

Text data 206 may be any desirable size, and includes subtitle text and/or graphics that may be displayed with one or more associated image frames and also may include style data to display the text and/or graphics. For example, style data may include, but is not limited to, a font identifier and/or definitional information, color, and/or size in which text may be displayed. Alternatively or in addition, style data may include control data to animate text data 206. For example, style data may select larger font sizes, capital letters, and italics for portions of text data 206 to indicate surprise, emphasis, and so on, for a character's lines. As another example, text data 206 may be presented with different image frames using different styles.

Text data 206 may be inserted into one or more image frames using a variety of known methods. For example, a processor within a display device or other computer may utilize the lookup tables, frame counters, control data and/or executable code to associate text data 206 with one or more image data frames. The processor may build an image frame and a bitmap for subtitle text data 206. Then the processor may, for example, overlay the subtitle text data 206 on top of the frame buffer. For each of the identified image data frames, depending on the selected style, subtitle text data 206 may block out the image data or be appear to be semitransparent. For example, where subtitle text data 206 is defined with a boundary, the textual characters may block out the image data, while the remainder of the boundary is transparent. The processor may also apply style data and/or control data to subtitle text data 206 as it is presented with subsequent associated image frames. The processor may animate subtitle text data 206 or apply different colors as it is presented with these subsequent associated image frames.

End of subtitle caption packet identifier 208 may also be used to identify the end of caption packet 100 and/or to locate a subsequent caption packet 101 or subtitle data packet 50. End of subtitle caption packet identifier 208 may also be used for error correction, as desired, and indicate an alarm or diagnostics signal when such errors arise.

Thus, it is apparent that there has been provided in accordance with the present invention, a system and method for associating subtitle data with cinematic material that satisfies the advantages set forth above. Although the present invention has been described in detail, it should be understood that various changes, substitutions, and alterations may be readily ascertainable by those skilled in the art and may be made herein without departing from the spirit and scope of the present invention as defined by the following claims.

What is claimed is:

1. A system for associating subtitle information with electronic cinematic material, comprising:
a distributor;
a signal structure operable to be electronically transferred from the distributor over a communication link;
a series of image data packets disposed in the signal structure;
subtitle data inserted into the series and associated with at least one of the image data packets.

2. The system of claim 1, wherein the subtitle data comprise text data represented in a plurality of languages.

3. The system of claim 1, wherein the subtitle data comprise text data and style data to be used to display the text data with data from the at least one of the associated image data packets.

4. The system of claim 1, wherein the subtitle data are inserted between two of the image data packets.

5. The system of claim 1, wherein the subtitle data comprise at least one caption packet.

6. The system of claim 1, wherein the subtitle data comprises:
a locator vector; and
text data to be displayed in at least one image frame derived from at least one of the associated image data packets using the locator vector.

7. The system of claim 1, wherein the signal structure is electronically received by a service provider.

8. A subtitled electronic cinematic feature, comprising:
a series of image data packets residing in a signal structure that may be electronically transferred over a communication link; and
subtitle data inserted into the series and associated with at least one of the image data packets.

9. The feature of claim 8 wherein the subtitle data comprise text data represented in a plurality of languages.

10. The feature of claim 8, wherein the subtitle data comprise text data and style data to be used to display the text data with data from the at least one of the associated image data packets.

11. The feature of claim 8, wherein the subtitle data are inserted between two of the image data packets.

12. The feature of claim 8, wherein the communication link comprises a wireless communication link.

13. The feature of claim 8, wherein the signal structure is transferred from a distributor using the communication link.

14. A method for associating subtitle information with cinematic material, comprising:
providing a series of image data packets in a signal structure that may be electronically transferred over a communication link;
associating subtitle data with at least one of the image data packets;
inserting the subtitle data into the series; and
receiving by a service provider the signal structure over the communication link.

15. The method of claim 14, wherein the communication link comprises a satellite communication link.

16. The method of claim 14, wherein the subtitle data comprise text data represented in a plurality of languages.

17. The method of claim 14, wherein the subtitle data comprise text data and style data to be used to display the text data with data from the at least one of the associated image data packets.

18. The method of claim 14, wherein the subtitle data are inserted between two of the image data packets.

19. The method of claim 14, further comprising electronically presenting at least a portion of the data within the signal structure.

20. The method of claim 14, wherein the subtitle data comprise graphics data to display with data from the at least one of the associated image data packets.
